(19) United States
(12) Patent Application Publication
(10) Pub. No.: US 2014/0308062 A1
(43) Pub. Date: Oct. 16, 2014

(54) MODULAR ACCESSORY CONNECTOR

(71) Applicant: PACIFIC CYCLE, LLC, Madison, WI (US)

(72) Inventors: Vladlena Belozerova, Madison, WI (US); Ian Cassiman, Cottage Grove, WI (US); Jesse C. Darley, Madison, WI (US); William R. Dorr, Madison, WI (US); Justen D. England, Madison, WI (US); Brian Koons, Middleton, WI (US); Jeffrey A. Rogers, Milford, NJ (US); Jim Slattery, Middleton, WI (US); Joseph J. Werwie, III, Sun Prairie, WI (US)

(73) Assignee: PACIFIC CYCLE, LLC, Madison, WI (US)

(21) Appl. No.: 14/250,123

(22) Filed: Apr. 10, 2014

Related U.S. Application Data
(60) Provisional application No. 61/810,589, filed on Apr. 10, 2013.

(51) Int. Cl. F16B 17/00

(52) U.S. Cl. CPC F16B 17/00
USPC 403/14

(57) ABSTRACT

A connector system for attaching accessories to a bicycle or other sporting good includes a base and a platform. The base is attached to a bicycle and the platform is attached to the accessory, and the base and the platform are held together by mechanical or magnetic forces.

### CROSS REFERENCE TO RELATED APPLICATION

This application is based on and claims priority to U.S. Provisional Patent Application No. 61/810,589 filed on Apr. 10, 2013, which is incorporated herein by reference in its entirety for all purposes.

### FIELD OF THE INVENTION

The present invention relates generally to the field of accessories for outdoor activities. More particularly, the present invention relates to connectors for removably attaching accessories to bicycles or other sporting goods.

### BACKGROUND

Cyclists often attach accessories to their bicycles, for example, water bottles, racks, pumps, locks, and lights. Over the years, cyclists have used a variety of methods for attaching accessories to bicycles by using a number of methods or connectors, including traditional “braze-ons,” where accessory mounts were brazed onto steel bicycle frames, as well as other methods including welding, gluing, screwing, riveting, or even simply taping or wiring. Many of these prior art methods and devices for attaching accessories to bicycles have one or more disadvantages. For example, tools are often needed to secure the connectors either to the bicycle or to the accessory. Some of these prior methods require the use of metal parts that may rust or become corroded due to the elements or may have rough edges that can catch on clothing. Additionally, prior methods of attaching accessories to bicycles are often be time consuming or otherwise cumbersome to use. Finally, different accessories may have different intended connections such that a cyclist must use a variety of connectors for mounting multiple accessories to his or her bicycle.

As such, there is a need for a simple and effective method for attaching accessories to bicycles or other sporting goods, where the connectors involve minimal use of tools, perhaps even no tools. There is also a need for connectors for attaching accessories where the connectors may be composed of standardized units or sections, either standardized for a particular bicycle or for a particular line of accessories, for manufacturing efficiency and for ease of use. There is also a need for connectors for which rust, corrosion or other deterioration from the elements is minimal, and where the connectors lack sharp points and rough edges.

### SUMMARY

The present invention is a connector having a base and a platform removably attached to the base. The base includes one or more retention tabs and the platform has one or more retention sections. The platform is removably attached to the base by selectively engaging the retention sections with the retention tabs. In certain embodiments, magnets are used to align the platform to the base, and may also provide holding force to hold the platform to the base. In still other embodiments, the retention tabs are movable in relation to the base. A displacement tab may be used to move the retention tabs from an open to a closed position.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1A is a top view of one embodiment of a connector in accordance with the invention.

FIG. 1B is a front view of the connector of FIG. 1A.

FIG. 1C is a side view of the connector of FIG. 1A.

FIG. 2 is an exploded view of the connector of FIG. 1A.

FIG. 3 is a perspective view of the connector of FIG. 1A.

FIG. 4 is a perspective view of one embodiment of a connector in accordance with the invention, showing a platform having magnets.

FIG. 5 is another perspective view of the connector of FIG. 4, showing the base and platform connected and showing the magnets in the base of the connector.

FIG. 6A is perspective view of one embodiment of a platform of a connector in accordance with the invention.

FIG. 6B is another perspective view of the platform of FIG. 6A.

FIG. 7A is a perspective view of one embodiment of a base of a connector that would work with the platform shown in FIGS. 6A and B.

FIG. 7B is another perspective view of the base of FIG. 7A.

FIG. 8 is a perspective view of one embodiment of a connector in accordance with the invention showing a platform pressed onto a base.

FIG. 9 is a perspective view of one embodiment of a connector in accordance with the invention showing a platform that is removably attached to a base by a twist-on and untwist-off interaction.

FIG. 10 is a perspective view of one embodiment of a connector in accordance with the invention showing a platform that is removably attached to a base by a slide-on and slide-off interaction.

FIG. 11 is a perspective view of one embodiment of a connector in accordance with the invention showing a bag that includes two platforms that removably attach to two bases.

FIG. 12 is a perspective view of one embodiment of a connector in accordance with the invention where a base and a platform are connected by sliding-on, and is disconnected by deactivating the connection and sliding-off.

FIG. 13 is a perspective view of another embodiment of connectors in accordance with the invention and shown used with a rear bicycle rack.

FIG. 14 is a perspective view of another embodiment of connectors in accordance with the invention, and shown used with a basket and straps.

FIG. 15 is a perspective view of another embodiment of connectors in accordance with the invention and shown used with accessories that attach to a helmet.

FIG. 16 is a perspective view of another embodiment of connectors in accordance with the invention shown used with non-functional accessories.

FIG. 17 is a perspective view of another embodiment of a connector in accordance with the invention showed for use with straps or tie-downs.

FIG. 18 is a perspective view of another embodiment of connectors in accordance with the invention shown used to attach accessories to a backpack.

### DETAILED DESCRIPTION

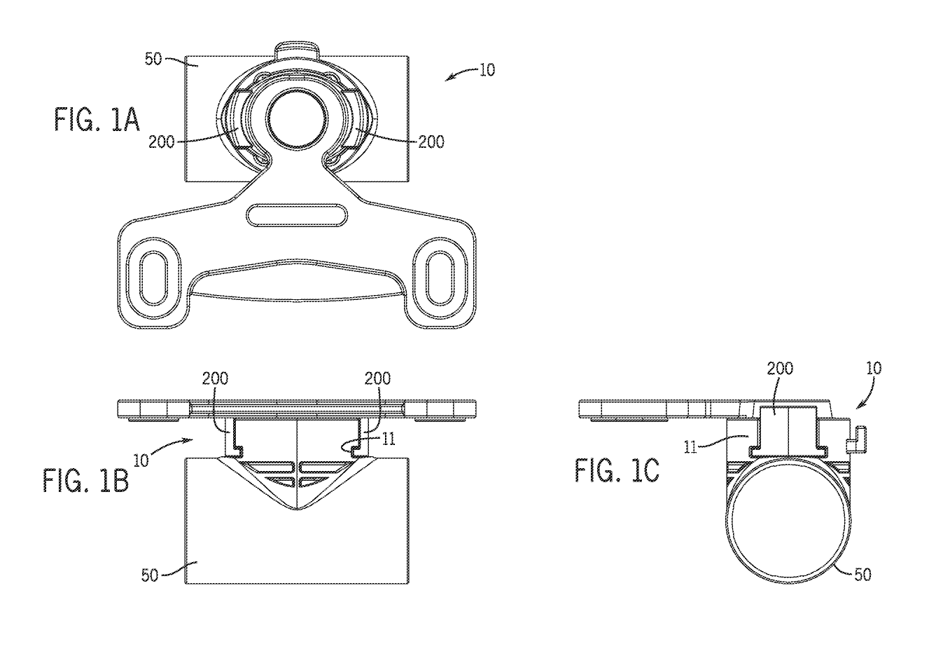

Referring to FIGS. 1-3 one embodiment of a connector 10 in accordance with the invention is shown. The embodiment shown includes a base 11 that is integrated into a tube 50 of a bicycle frame. As shown, base 11 includes retention tabs 200 that are movable with respect to the base. The retention tabs 200 are slidably attached to base 11 and slide between open and closed positions. As shown, each of the retention tabs 200 are biased toward the closed position by a spring 202. In alternative embodiments, the retention tabs 200 may be biased toward the closed position by any suitable means. In another embodiment, the retention tabs 200 may be biased toward the open position, and when a platform 12 is attached to base 11, magnetic force may be used to move and hold the retention tabs in the closed position.

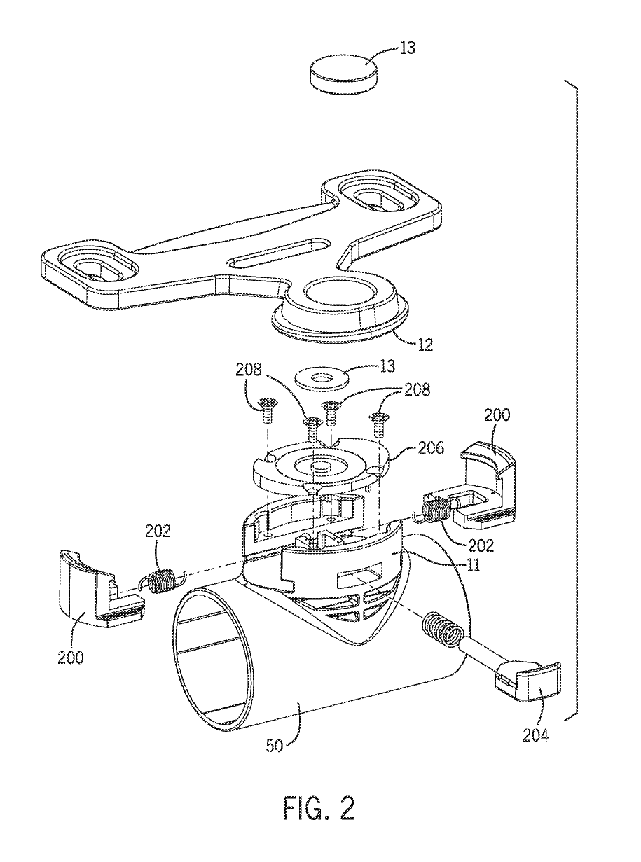

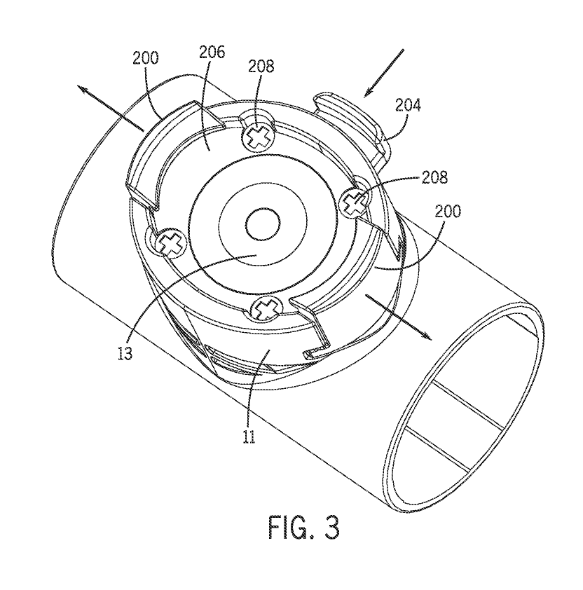

FIG. 2 shows a displacement tab 204 that allows platform 12 to be removed from base 11 when pressed. In the embodiment shown, the retention tabs 200 and displacement tab 204 are captured between the base 11 and a base plate 206. The base plate is attached to the base 11 by a plurality of screws 208, although any suitable attachment means may be used. Magnets 13 are included in this embodiment and provide alignment and holding force to the platform 12 with respect to the base 11. FIG. 3 shows how pressing displacement tab 204 moves retention tabs 200 from the closed to the open position, thereby allowing the platform 11 to be removed from the base 12.

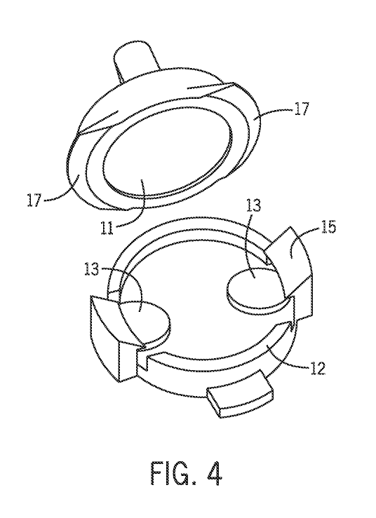

Referring to FIGS. 4-9, multiple embodiments of a connector 10 in accordance with the invention that includes a base 11 and a platform 12 are shown. In some embodiments, base 11 and platform 12 may each contain one or more magnets 13. Although not required, magnets provide a useful mechanism for both aligning base 11 to platform 12 and holding them together with a sufficiently strong bond to support the weight of an accessory. As shown in FIGS. 1-18, and as would be readily apparent to one of ordinary skill in the art, any other suitable attachment mechanisms could be used to attach base 11 to platform 12 without departing from the invention. Connectors 10 in accordance with the invention may be used for a variety of applications, including for attaching accessories to bicycles, but also for other applications such as other sports as well as for storage and organizing items. Connectors 10 in accordance with the invention are particularly well suited for outdoor use because they are durable and will hold up well when exposed to various weather and use conditions, and are convenient in that they may be used with only minimal or perhaps even no tools. Of course, connectors 10 may be used indoors as well without departing from the invention. It is contemplated that multiple bases 11 may be attached or integrated into an item such as a bicycle, and that any accessory having the corresponding platform 12 may be attached to any of the bases.

In certain embodiments or uses, the bases may be “universal” in that they allow numerous attachment methods for attaching platforms 12 to bases 11. This universality includes features that allow sliding, twisting, snapping onto, attaching with magnets, etc. Additionally, the bases 11 may have no projecting or delicate parts, which minimizes the likelihood of breaking a semi-permanent part of a bike and minimizes the likelihood of catching clothing or other objects on the bases if no accessory is attached. As well, connectors 10 in accordance with the invention could be standard for a line of accessories or for a particular brand of bicycle, such that consumers would be able to use similar connector functionality for all of their accessories for their bicycles.

Referring back to FIGS. 1-9, several different embodiments of connectors 10 in accordance with the present invention are shown. The embodiments shown in FIGS. 1-9 are well suited for use with bicycles, but may be used in any suitable place with. In these embodiments, it is contemplated that base 11 would be attached to a bicycle; this attachment could be accomplished in a variety of ways that would be readily accomplished by a person of ordinary skill in this art, including for example, attachment via zip ties, o-rings, bands, gluing, screws, rivets, or may even be integral with or molded into the bicycle frame. Bicycles may be sold with one or more bases 11 attached or included, or bases and platforms 12 could be sold separately. Similarly, in the exemplary embodiments, it is contemplated that platform 12 would be attached to or integral with an accessory 14 to be mounted to a bicycle.

Accessories could be sold with one or more platforms 12 attached or included, or they could be sold separately such that the consumer could attach platforms to any accessory desired. It should also be mentioned that base 11 and platform 12 may be switched or flipped as necessary, i.e. to attach the base to the accessory and to attach the platform to the bike or other mounting surface.

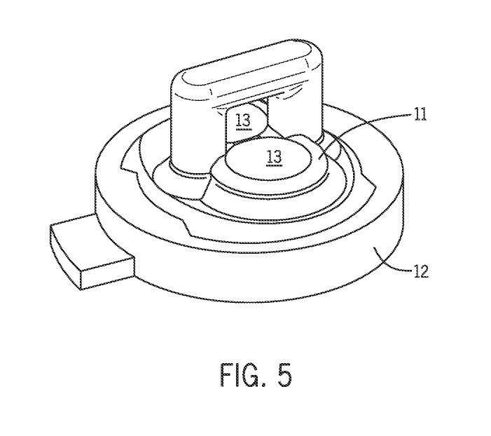

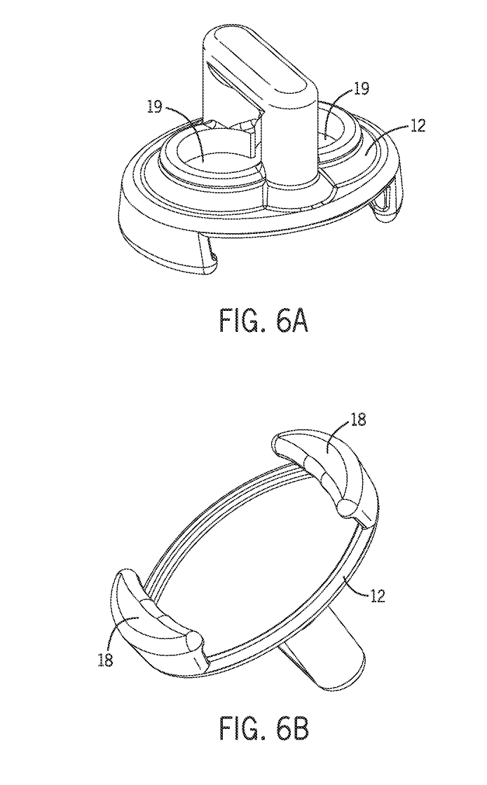

FIGS. 4 and 5 depict a connector 10 in accordance with the invention that uses magnets 13. In the embodiment shown, base 11 contains two magnets 13 and platform 12 contains two magnets 13 as well. As a user moves platform 12 near base 11, the magnets 13 help align and pull the parts together. The interaction between base 11 and platform 12 is also assisted by a rotation of base 11 with respect to platform 12 when base is inserted or connected to the platform. As shown in FIG. 6, the aperture or space in platform 12 which allows the insertion of base 11 is shaped generally to allow insertion of base 11. When base 11 is inserted, magnets 13 in the base 11 and in the platform 12 cause base 11 to be twisted 90 degrees such that tabs 17 on base 11 are slid into a retaining sections 18 on platform 12. To dislodge base 11 and platform 12, the user twists the accessory or platform 12 to release tabs 17 from retaining sections 18 and pulls the platform 12 to overcome the magnetic force holding it to base 11.

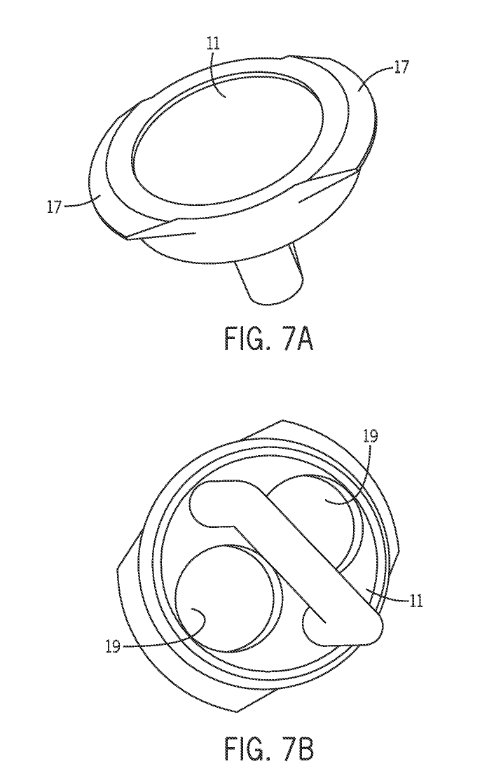

FIGS. 6 and 7 show two pieces of an embodiment of a connector 10, namely a base 11 and a platform 12 that contain magnets and operate similarly to the connector shown in FIGS. 6 and 7. FIG. 6 shows two views of a platform 12. FIG. 6A shows the top view of platform 12 and FIG. 6B shows the bottom view of platform 12. Also shown are magnet detents 19 for holding two magnets in platform 12 and retaining sections 18. FIG. 7 shows two views of base 11. FIG. 7A shows the top view of base 11 and FIG. 7B shows the bottom view of base 11. Also shown in FIG. 7 are magnet detents 19 for holding two magnets in base 11 and tabs 17 that would be held in place by retaining sections 18 of the platform 12. When the parts shown in FIGS. 6 and 7 would be used together, base 11 is inserted into platform 12 and magnets 13 in the base 11 and in the platform 12 cause base 11 to be twisted 90 degrees such that tabs 17 on base 11 are slid into a retaining sections 18 on platform 12. To remove base 11 from platform 12, the user twists the accessory or platform 12 to release tabs 17 from retaining sections 18 and pulls the platform 12 to overcome the magnetic force holding it to base 11.

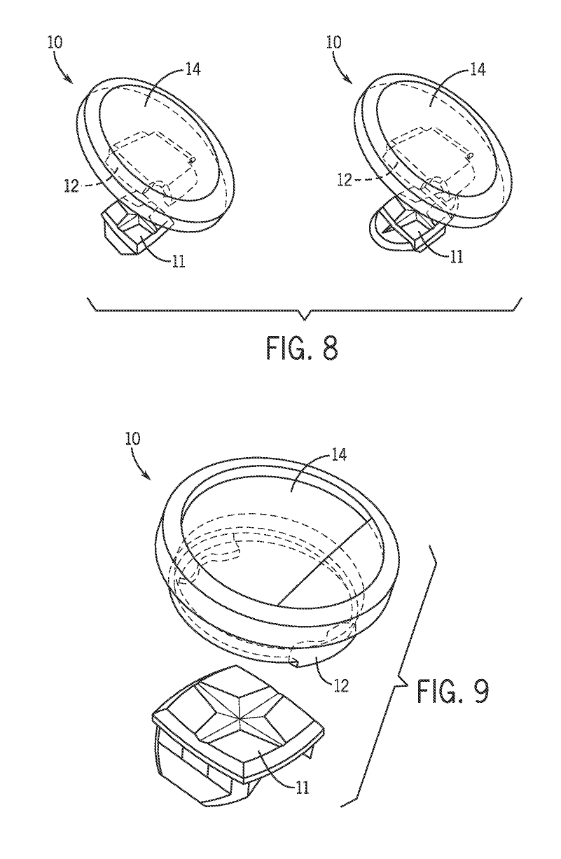

Referring to FIG. 8, this figure illustrates a connector 10 intended for smaller accessories such as head lights and tail lights. In this connector 10, the platform 12 mounted to the accessory 14 can be placed near or pushed on the base 11, which is mounted to a bicycle, to engage the platform 12 and base 11. To disengage the platform 12 from base 11, the platform can simply be pulled off using light force. The embodiment shown in FIG. 8 could use magnets to assist in the interaction between base 11 and platform 12, but this embodiment could also be used without magnets. As an alternative, base 11 and platform 12 could fit together by simple mechanical means. Magnets may be used to align the platform 12 to base 11, and may also provide holding force as well. If a mechanical mount is used, the user will have to push the platform onto the base.

FIG. 9 illustrates another embodiment of a connector 10 in which the base 11 and platform 12 are secured using a twist-on, twist-off mechanism. As shown, base 11 is secured to the bicycle, and platform 12 is secured to the accessory 14. Accessory 14 is then attached to the bicycle by twisting platform 12 onto base 11. Accessory 14 is removed by untwisting platform 12 from base 11. In this embodiment, magnets could be used to bias the platform-base toward an “attached” orientation.

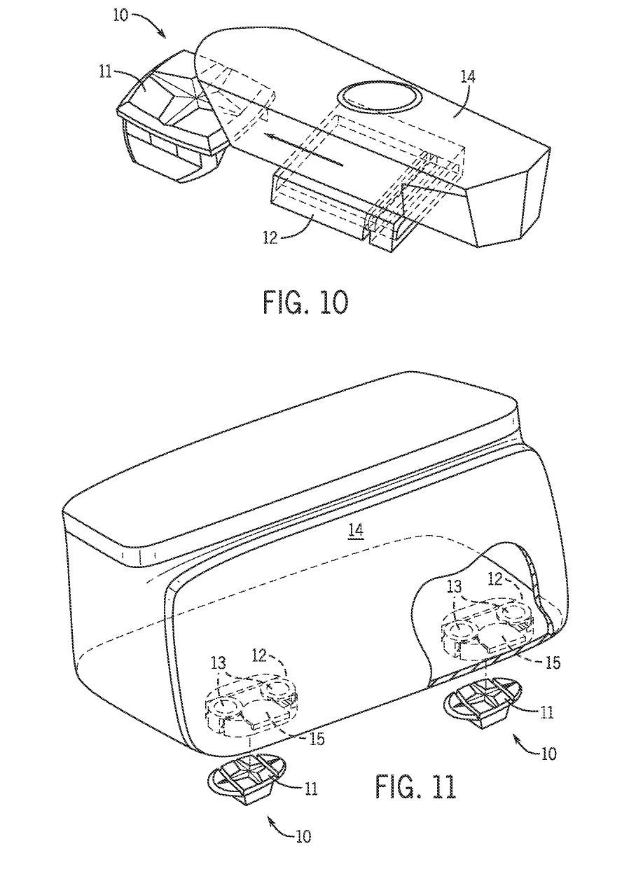

FIG. 10 shows an embodiment of a connector 10 in which the platform 12 slides onto and off of base 11. This mechanism may be well suited for longer objects that don't need high security or require frequent removal, such as a water bottle or headlight. As in the previous embodiments, base 11 may be attached to the bicycle by any suitable method, including for example by way of a cam lock to the handlebar of the bicycle or by fastening to the braze-ons of a down tube. Platform 12 is attached to accessory 14. To attach accessory 14 to the bicycle, a user slides platform 12 onto base 11. To remove, platform 12 is slid off. Magnets could be employed to bias the platform and base to connect the accessory to the bicycle or to provide some holding force to keep the platform 12 in place when installed onto base 11.

FIG. 11 illustrates two connectors 10 being used to secure a larger accessory, and illustrates an embodiment of a connector that has a deactivating mechanism that provides additional security for the accessory. For larger accessories, it may be useful to use more than one connector to provide a more stable and secure base. In the example shown in FIG. 11, using multiple connectors 10 also allows soft or flexible accessories to be attached securely in a way that the accessory will not be displaced during use. The platforms 12 of connectors 10 shown in FIG. 11 may be attached to bases 11 by placing them near or pushing them on bases 11. If magnets 13 are used, when placing the platforms 12 near bases 11, magnetism will assist the user in attaching the accessory and aligning platforms 12 to attach to bases 11. If no magnets are used, the user may simply push platforms 12 onto bases 11 for a snap-fit connection or a friction-fit connection. Deactivators 15 may be used to assist with securely connecting larger or more expensive accessories. For example, the deactivator 15 shown in FIG. 11 is a push-in tab that releases a part of the connection between platform 12 and base 11.

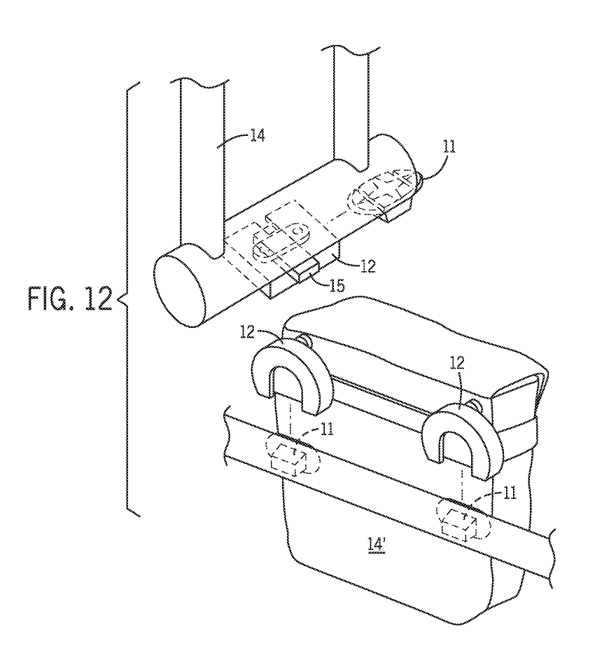

FIG. 12 shows two embodiments of a slide-on and slide-off types of connectors 10. Long or heavy accessories may work well with sliding connections, for example where platforms are dropped on to bases or are pushed onto bases for a snap-fit or a friction-fit connection. One connector 10 in FIG. 12 is illustrated for use with a U-lock as accessory 14, and also includes a deactivator 15. Platform 12 is attached to the U-lock and includes a deactivator tab for additional security, i.e., that the deactivator must be pressed to deactivate and to release platform 12 from base 11. FIG. 12 also illustrates another embodiment of slide-on connectors, shown with a pannier as accessory 14′.

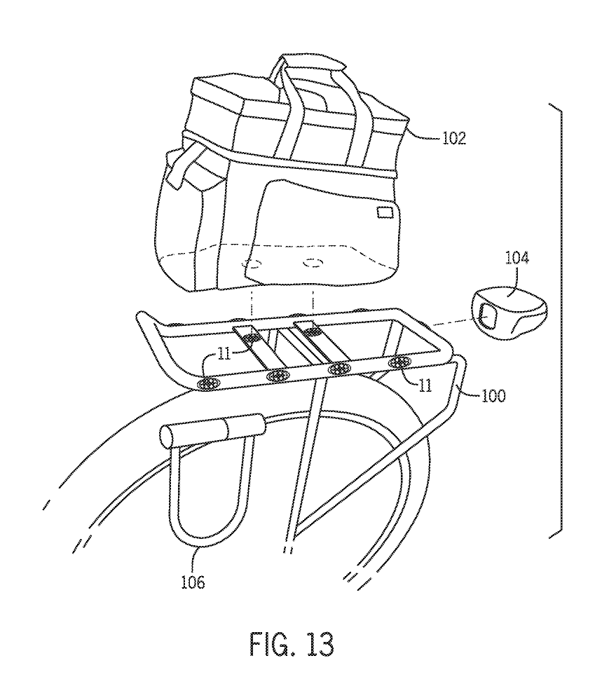

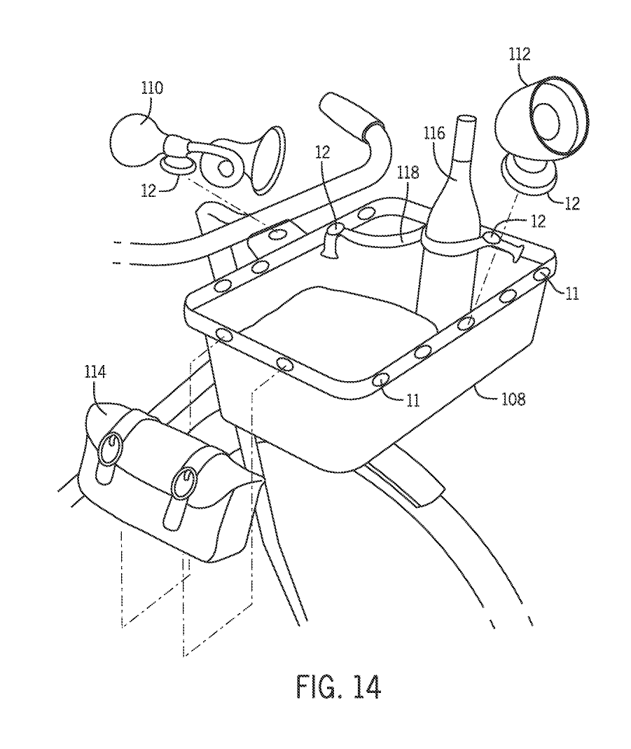

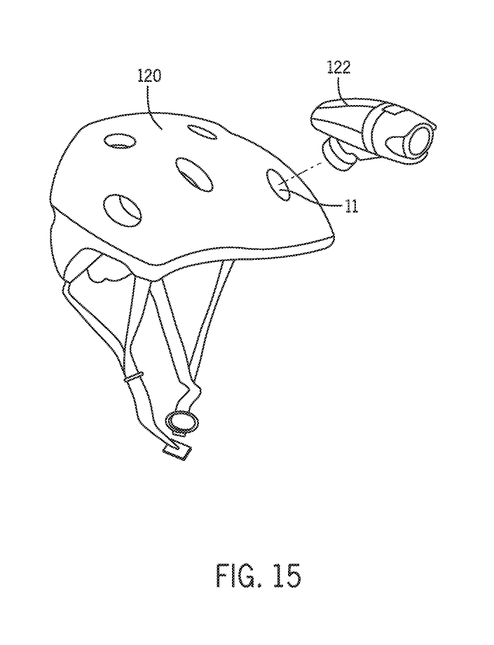

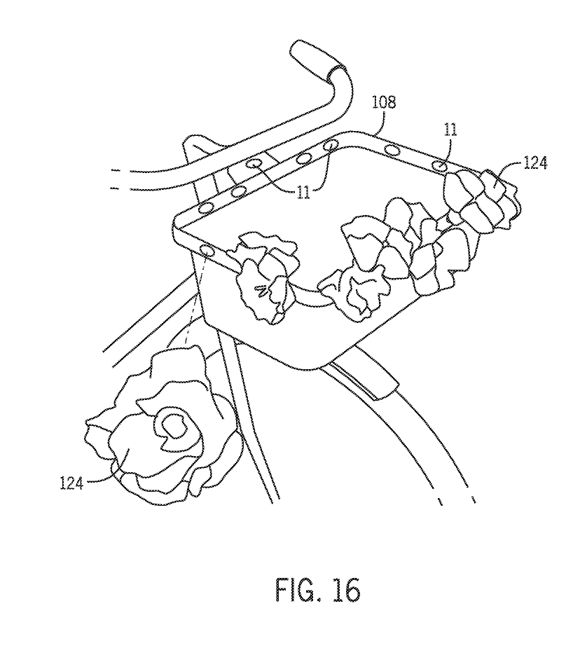

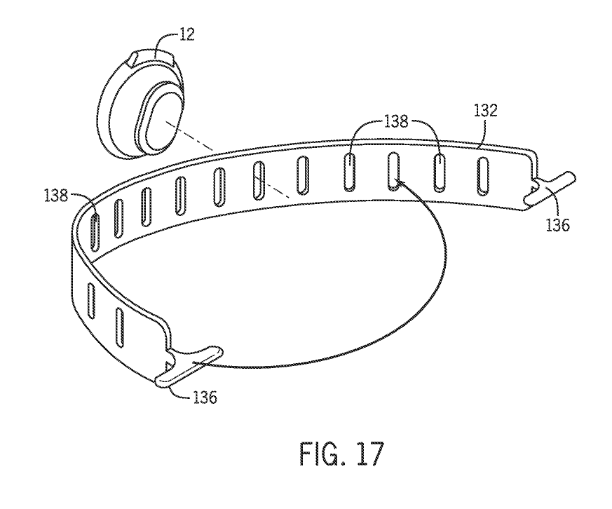

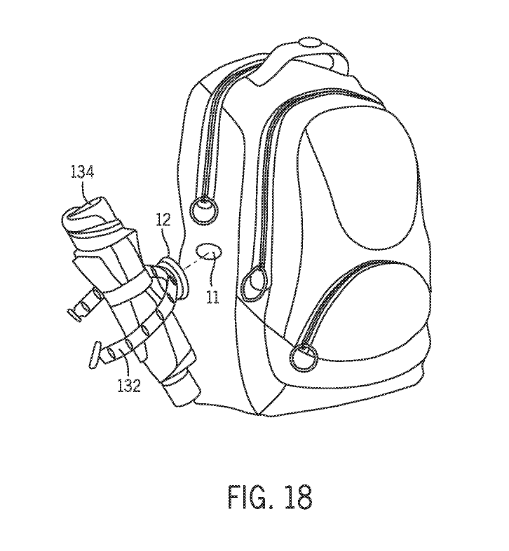

FIGS. 13-18 show examples of uses of connectors 10 in accordance with the invention. FIG. 13 shows a bicycle rack 100 incorporating a plurality of bases 11 onto which accessories such as a travel bag 102, rear light 104, or u-lock 106 may be connected. As shown, each accessory includes identical platforms 12 that removably attach to the plurality of bases 11. FIG. 14 shows a basket 108 for a bicycle that similarly incorporates a plurality of bases 11. As shown, a horn 110, front light 112, and bag 114 are attached to the basket 108. Also shown is a wine bottle 116 that is secured inside the basket 108 by a strap 118 having platforms 12 at each end of the strap. Similar straps may have a multitude of platforms 12 that would allow a user to secure items of various sizes inside the basket 108. FIG. 15 shows a helmet 120 having a base 11 onto which a light 122 or any other accessory may be attached. FIG. 16 shows a basket 108 as shown in FIG. 14, but showing decorative flowers 124 attached to the basket rather than the functional accessories of FIG. 14. Of course, a user could attach a combination of functional and decorative accessories without departing from the invention. FIGS. 17-18 show an embodiment of the connector 10 having a base 11 integrated into a backpack 130, with the platform attached to an adjustable strap 132. The embodiment shown allows a user to attach an item such as an umbrella 134 that does not include a platform 12 to the backpack 130. The adjustable strap 132 is flexible and includes tabs 136 that may be inserted into one of a plurality of slots 138 to secure the strap.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A connector comprising:
a base having one or more retention tabs;
a platform having one or more retention sections;
the platform removably attached to the base by selectively engaging the retention sections with the retention tabs; and
the base and the platform each including at least one magnet to align the platform to the base.

2. The connector of claim 1, wherein the magnets provide holding force when the platform is attached to the base.

3. The connector of claim 1, wherein the base is integrated into the frame of a bicycle.

4. The connector of claim 1, wherein the base is removably attached to the frame of a bicycle.

5. The connector of claim 1, wherein the platform is integrated into an accessory.

6. The connector of claim 1, wherein the platform is removably attached to an accessory.

7. The connector of claim 1, wherein the retention tabs are slidably attached to the base and move between an open and a closed position.

8. The connector of claim 7, wherein the connector further includes a displacement tab that moves the retention tabs from the closed position to the open position.

9. The connector of claim 7, wherein the retention tabs are biased toward the closed position by springs.

10. The connector of claim 1, wherein the platform is removed from the base by twisting the platform in relation to the base to disengage the retention tabs.
